(19) United States
(12) Patent Application Publication
(10) Pub. No.: US 2006/0026287 A1
(43) Pub. Date: Feb. 2, 2006

(54) Embedded processes as a network service

(75) Inventor: Noah J. Ternullo, Pittsburgh, PA (US)

Correspondence Address: MILES & STOCKBRIDGE PC, 1751 PINNACLE DRIVE, SUITE 500, MCLEAN, VA, 22102-3833, US

(73) Assignee: Lockheed Martin Corporation

(21) Appl. No.: 10/902,577

(22) Filed: Jul. 30, 2004

(51) Int. Cl. G06F 15/16

(52) U.S. Cl. 709/227

(57) ABSTRACT

Disclosed is a system and method for providing access to embedded processes as a network service Software proxies within the server route message traffic to one or more embedded processes. A server proxy and an embedded process handling proxy establish the connection between server and embedded processes. The embedded process handling proxy and/or the server proxy map the external identifiers to internal identifier corresponding to one or more embedded processes. The embedded process handling proxy abstracts the network processing away from the embedded processes and allows them to remain dedicated to their specialized functions.

This invention relates generally to client-server computing. In particular, this invention relates to systems and methods for accessing embedded processes as network services.

Server computers may contain processes, such as embedded processes. A process, as used herein, refers to any manipulation of data and may be accomplished through the use of software, hardware, or a combination of software and hardware. Embedded processes are commonly used to perform specialized tasks for which the embedded process may be uniquely optimized such as, for example, to perform a specific task with increased efficiency and/or speed. Representative examples of embedded processes include hardware accelerators, general-purpose processors, and the like. Hardware accelerators may be used, for example, to parse extensible markup language (XML), perform cryptographic operations, process computer graphics, and/or for any other application where it may be advantageous to accelerate data processing. Embedded general-purpose processors may be used, for example, to perform logic operations, database transactions, and the like. In client-server computing there may be many present and future developments that could utilize embedded processes.

A traditional method of accessing embedded processes within a server is known in the industry as “port forwarding.” As an example of the port forwarding method, the embedded processes are mapped to Internet Protocol (IP) address/port number combinations that contain a port number that is not well-known. In the industry, well-known port numbers are those port numbers that are used by default when accessing various types of services across the network. By having a set of well-known port numbers, the industry makes it possible for clients and servers to communicate without having to establish which port numbers to use each time a connection is desired. It is understood that, when accessing a service on another computer, the well-known port number is the port number to use, unless special circumstances dictate otherwise. The port forwarding method requires that clients desiring to access the embedded processes be configured to use port numbers that are not well-known. In so doing, the port forwarding method requires knowledge of the non-well-known port number prior to connection between the client and the embedded processes. This limitation has the effect of creating a system that is at odds with standards-based client-server computer networking. In addition, port forwarding may require manual configuration of clients and servers, which is time consuming and expensive.

The exemplary systems and methods of this invention are directed toward embedded processes as network services, which are accessible in a manner consistent with client-server computer networking industry standards, for example, by means of an IP address and a well-known port number. For simplicity of reference, the systems and methods of the invention will hereafter refer to the device and/or process requesting access to the embedded process as the client, and to the device and/or process that is associated with the embedded process as the host server. The client and/or host server may be software, hardware, or any combination of software and hardware.

Generally, in client-server computing, the client may seek to initiate a transaction with a server by sending a message across the network containing an identifier that corresponds to the server. An identifier may be, for example, an IP address, host name, or the like. If the server is available and permits the client to connect, the server will respond with a message across the network directed to an identifier that corresponds to the client. Once a connection has been established, the client and server may exchange data.

In situations where embedded processes are used, the client will be seeking to access one or more embedded processes across the network. In so doing, the client will send a message containing an identifier that corresponds to the embedded process. Traditionally, for example, this identifier has been an IP address combined with a non-well-known port number, but could also be a host name, or the like. The host server receives the message with the identifier and routes the message to the embedded process. The embedded process then generates a response message, transmits the response message to the host server, and the host server transmits, via the network, the response message with an identifier designating the client.

For example, in an exemplary embodiment of the invention, the client places a message on the network with an identifier, for example, an IP address/well-known port number combination, corresponding to the embedded process. The host server, which is interconnected with the embedded processes, has previously established a server proxy to facilitate the communication between the host server and the embedded processes. The server proxy is essentially a server that acts as an intermediary between the client user and the embedded process. The embedded processes establish an embedded process handling proxy to communicate with the server proxy. The server proxy or the embedded process handling proxy may, for example, contain transfer control protocol/internet protocol (TCP/IP) stacks. The embedded process handling proxy acts as an intermediary between the embedded process and the host server. Through the two proxies, clients attached to the network can access the embedded processes as though the embedded processes were servers, for example, with their own unique IP addresses. The intermediary layers of the server proxy and embedded process handling proxy are transparent to the client. To the client, the embedded process may appear as though it is a server, such as, for example, a standalone server with a dedicated IP address. By utilizing well-known port numbers, an exemplary embodiment of the present invention does not require clients to have knowledge of the configuration of the server, in contrast to the port forwarding method. Thus, the present invention can avoid the time and expense involved with traditional methods of accessing embedded processes.

In an exemplary embodiment of the present invention, the embedded processes may appear to clients on the network as servers, which may for example, be secure. These embedded processes may be located within a host server, for example, in memory, on a separate electronics card, or the like. In still another exemplary embodiment of the present invention, the embedded processes may function as servers that are secure and high speed in order to meet the demands that may be present in transaction processing encountered in such applications as product ordering, finance, banking, and the like.

### BRIEF DESCRIPTION OF THE DRAWINGS

FIG. 1 is a functional block diagram of an exemplary system for accessing embedded processes as network services according to this invention.

FIG. 2 is a functional block diagram of an exemplary system for accessing embedded processes as network services according to this invention;

FIG. 3 is a functional block diagram of an exemplary system for accessing embedded processes as network services according to this invention, wherein the server proxy partially resides in the embedded process;

FIG. 4 is a functional block diagram of an exemplary hardware configuration of an electronic circuit card containing the embedded processes according to this invention;

FIG. 5 is a functional block diagram of two exemplary configurations of the embedded process circuit card network connections according to this invention;

FIG. 6 is a functional block diagram of an exemplary semiconductor device that has been configured as an embedded process according to this invention;

FIG. 7 is a diagram outlining an exemplary message flow between a client and an embedded process according to this invention;

FIG. 8 is a diagram outlining an exemplary message flow between a client and an embedded process according to this invention;

FIG. 9 is a flowchart outlining an exemplary method for accessing embedded processes as network services according to this invention; and

FIG. 10 is a flowchart outlining an exemplary method for accessing embedded processes as network services according to this invention.

### DETAILED DESCRIPTION

The exemplary systems and methods of this invention will be described in relation to a client-server computing. However, to avoid unnecessarily obscuring the present invention, the following description omits well-known structures and devices that may be shown in block diagram form or otherwise summarized. For the purposes of explanation, numerous specific details are set forth in order to provide a thorough understanding of the present invention. It should be appreciated however that the present invention may be practiced in a variety of ways beyond these specific details.

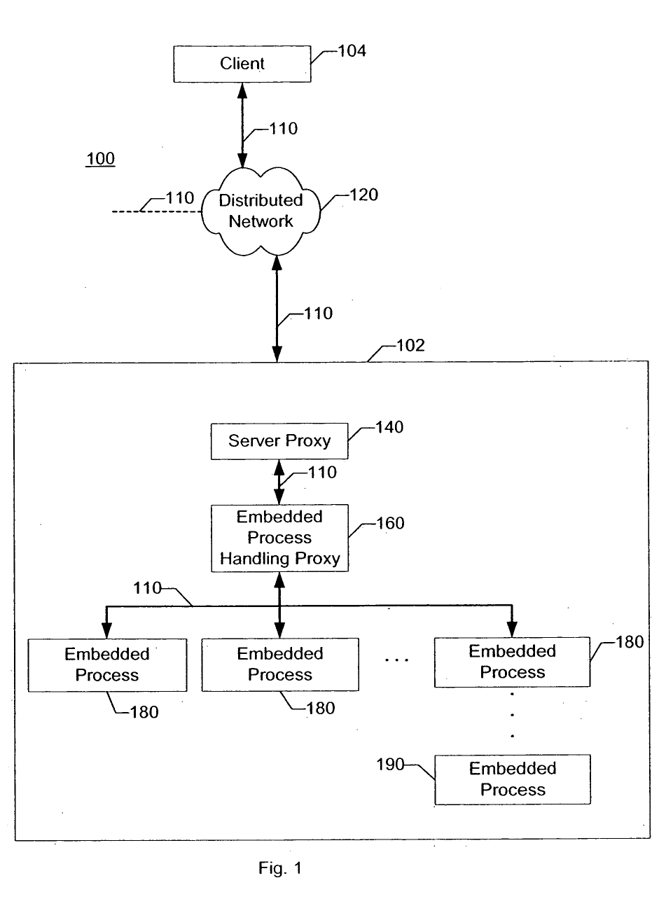

FIG. 1 shows a functional block diagram of an exemplary system 100 for accessing embedded processes as network services. In particular, a client 104 may be connected to one or more distributed networks 120 by link 110. A host server 102 comprises, in addition to standard server components, a server proxy 140, an embedded process handling proxy 160, one or more embedded processes 180, and, optionally, one or more nested embedded processes 190, all interconnected by links 110. The host server 102 may be connected, via link 110, to one or more distributed networks 120, which may or may not be connected to other distributed networks.

The links 110 can be a wired or wireless link, or any other known or later developed element(s) that is capable of supplying and communicating data to and from the connected elements.

In operation, the client 104 transmits a message containing an external identifier across the network 120. The host server 102 receives the message and determines, from the external identifier, that the message is designated for the server proxy 140. The host server transfers the message to the server proxy 140. The server proxy 140 receives the message and maps the external identifier to an internal identifier corresponding to one or more embedded processes 180. Based on the internal identifier, the message may be transferred to the embedded process handling proxy 160. The embedded process handling proxy 160 transfers the message to an embedded process 180 that corresponds to the internal identifier. The embedded process 180 may perform a data processing function on the message and/or may take an action, such as, for example, generating a response message. The response message is then transferred to the embedded process handling proxy 160, which transfers the message to server proxy 140. In an exemplary embodiment of the present invention, server proxy 140 converts the internal identifier to an external identifier before placing the message onto the network 120, via link 110, for return to the client 104

The mapping of external identifier to internal identifier may be accomplished on the host server 102, the server proxy 140, the embedded process handling proxy 160, or a combination of any of the three. The embedded process handling proxy 160 may map the external identifier to internal identifier in order to maximize server offload using, for example, a table lookup. Further, the packet payload content may be inspected by the element performing the external identifier to internal identifier mapping in order to determine the most appropriate embedded process to handle the request. The embedded process 180, the embedded process handling proxy 160, the server proxy 140, or any combination of the three may accomplish the reverse mapping of the internal identifier to the external identifier.

In receiving a message for processing, the embedded process 180 may further transfer the message to one or more nested embedded processes 190. The embedded process 180 and the nested embedded process 190 may be in a client-server relationship similar to the relationship between the client 104 and the host server 102. The embedded process 180 and the nested embedded process 190 may communicate through a proxy arrangement, such as a server proxy interconnected with the embedded process, and an embedded process handling proxy interconnected with the nested embedded process. Such a configuration may be useful, for example, where it may be advantageous to divide a data processing task between several embedded processes for improved speed and/or efficiency

Further, the exemplary embodiment shown in FIG. 1 may be comprised entirely of software components, for example. In a pure software embodiment of the invention, the client 104, host server 102, server proxy 140, embedded process handling proxy 160, embedded process 180, and embedded process 190 are, for example, object-oriented software components The links 110 are a software interconnection method, such as, for example, Common Object Request Broker Architecture, or CORBA.

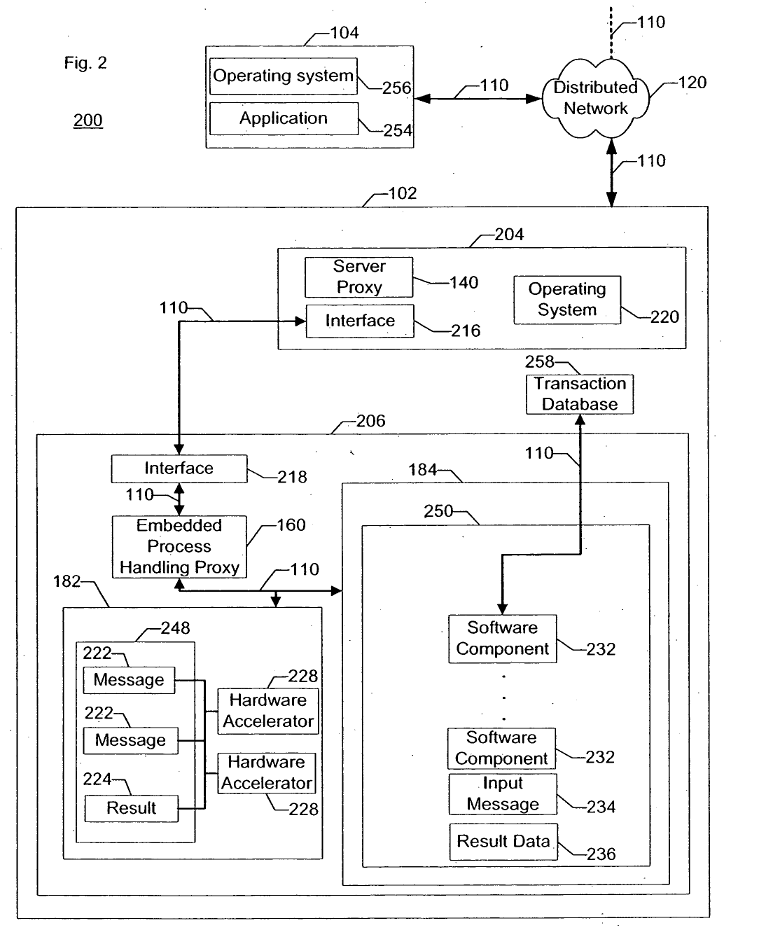

FIG. 2 shows a functional block diagram of an exemplary embodiment of a second system 200 for accessing embedded processes as network services. In particular, the client 104 comprises, in addition to the standard client components, an operating system 256 and one or more applications 254. The client 104 is connected to the distributed network 120 by a link 110. The host server 102 comprises, in addition to the standard server components, a server computer 204, an embedded process unit 206, and a transaction database 258. The embedded process unit 206 comprises, in addition to the standard peripheral components, an interface 218, an embedded process handling proxy 160, and two embedded processes, an embedded accelerator 182 and an embedded general-purpose processor 184, all interconnected by links 110. The embedded accelerator 182 comprises a memory 248, and one or more hardware accelerators 228. The memory 248 of the embedded accelerator 182 stores the input message 222 and result data 224 generated by the hardware accelerator 228. The embedded general-purpose processor 184 comprises, in addition to the standard general-purpose computer components, a memory 250. The memory 250 comprises software components 232, input message 234 and result data 236.

The application 254 within the client 104 may be a computer software program that seeks to access an embedded process. However, it should be appreciated that client 104 can be any software process, hardware process, or combination of software and hardware process capable of communicating with the host server 102, and that any such client may be used with equal success.

The server computer 204 comprises, in addition to the standard server computer components, a server proxy 140, an interface 216, and an operating system 220. In an exemplary embodiment, the operating system 220 may be Windows 2000® published by Microsoft Corp®. The server computer 204 may communicate with other computers across the network 120 using standard protocols. Examples of standard protocols include, for example, hypertext transfer protocol (HTTP), Internet Inter-ORB Protocol (IIOP), remote method invocation (RMI), simple mail transfer protocol (SMTP), secured sockets layer (SSL), secure hypertext transfer protocol (SHTTP) and the like. Examples of a network 120 include wired or wireless solutions such as Ethernet, fiber optic, or the like. However, it should be appreciated that any present or future developed operating systems, networks, and network protocols which perform the tasks required for a server to function, may be used with equal success according to the present invention.

In operation, the application 254 communicates a message containing an external identifier over network 120. The host server 102 receives the message and transfers the message to the server proxy 140. The server proxy decodes the external identifier and maps the external identifier to an internal identifier, which corresponds to an embedded process. An example of a table used for this mapping process is shown in Table 1 below. In Table 1, the external identifier is an IP address/port number combination and the internal identifier is a bus address. For example, a message containing the IP address 64.9.206.3 and port number 80, the well-known port number for the HTTP protocol, will be mapped to internal identifier 0xB0000000, which is the hexadecimal address for accessing an embedded process. However, it should be appreciated that Table 1 is shown for purposes of illustration and is merely an example of an external to internal identifier map, and any mapping system that is capable of associating an external identifier with an internal identifier corresponding to an embedded process could be used with equal success according to this invention.

TABLE 1

| External Identifier | Internal Identifier | Embedded Process |
|---|---|---|
| 64.9.206.2:80 | 0xA0000000 | I |
| 64.9.206.3:80 | 0xB0000000 | J |
| 64.9.206.4:80 | 0xC0000000 | K |
| 64.9.206.5:80 | 0xD0000000 | L |

In the exemplary embodiment of the present invention shown in FIG. 2, the embedded general-purpose processor 184 comprises a memory 250 containing standard software components 232. For example software components 232 may comprise key management, intrusion detection system (IDS), firewall, Simple API for XML (SAX), XML output, JDom (Java representation of an XML document), a session bean, an entity bean, and/or the like. The configuration of software components 232 in any particular embodiment may be adapted to the contemplated use of the embedded general-purpose processor 184 within the particular embodiment in accordance with the present invention.

In an exemplary embodiment of the present invention, the embedded processes 182 and 184 may appear as nodes on the network. The server proxy 140 may be a software proxy created within the server computer 204. The server proxy 140 utilizes the server system 102 network hardware and software (not shown) to make the embedded processes 182 and 184 available across the network 120 to clients 104. In an exemplary embodiment of a server proxy 140, a separate TCP/IP stack may be created for each embedded processes 182 and 184.

The embedded process handling proxy 160 abstracts away the communications details involved in networking for the embedded processes 182 and 184. The embedded process handling proxy 160 enables the embedded processes 182 and 184 to remain dedicated to their respective tasks and to reduce and/or eliminate allocation of resources to ancillary tasks, for example, network data processing.

In FIG. 2, the server proxy 140 communicates through an interface 216 via link 110 to the interface 218, which is in turn interconnected with embedded process handling proxy 160. For example, link 110 shown in FIG. 2 interconnecting interface 216 and interface 218 may be a Peripheral Component Interconnect (PCI) bus interface, for example. However, it should be appreciated that other data transfer protocols and interfaces may be used with equal success. The server proxy 140 and embedded process handling proxy 160 may communicate with each other using whatever communication medium and protocols the server uses. In an exemplary embodiment of the present invention, the server proxy 140 may also contain a buffer for storing data received via network 120 and transfers the data in the buffer to the embedded process handling proxy when the buffer is full or when a timeout condition is reached.

For example, the hardware accelerators 228 shown in FIG. 2, may be adapted to comprise an XML accelerator and a triple data encryption standard (3DES) accelerator. The packets received may be formatted in accordance with the standards applicable to the communication protocol, for example TCP/IP. As further example, in the case of encrypted packets, the packets would be formatted in accordance with the Internet Protocol Security Encapsulated Security Packets (IPSEC ESP) packet standards. The memory 248 of the embedded accelerator 182 may contain an XML document in a message 222, an Encapsulating Security Payload (ESP) message 222, and space for a clear, unencrypted message result 224. In operation, the client 104 seeks to access a 3DES hardware accelerator 228, an encrypted message 222 is received from a client 104 via the network 120. The server proxy 140 receives the message and decodes the address and maps the external address/port number to an internal address of an embedded process 182 and/or 184. The server proxy 140 then transfers the message across the link 110 to the embedded process handling proxy 160. The embedded process handling proxy 160 then stores the message in memory 248. The encrypted message 222 must be decrypted prior to further processing. The encrypted message 222 is decrypted by the 3DES accelerator 228 and stored in memory 248 as a an unencrypted message 224. The unencrypted message 224 is processed by the XML accelerator 228 and stored as an XML document 222. The general-purpose processor 184 can now process the XML document 222, upon transfer of the XML document in message 222 to the embedded general-purpose processor 184 memory 250.

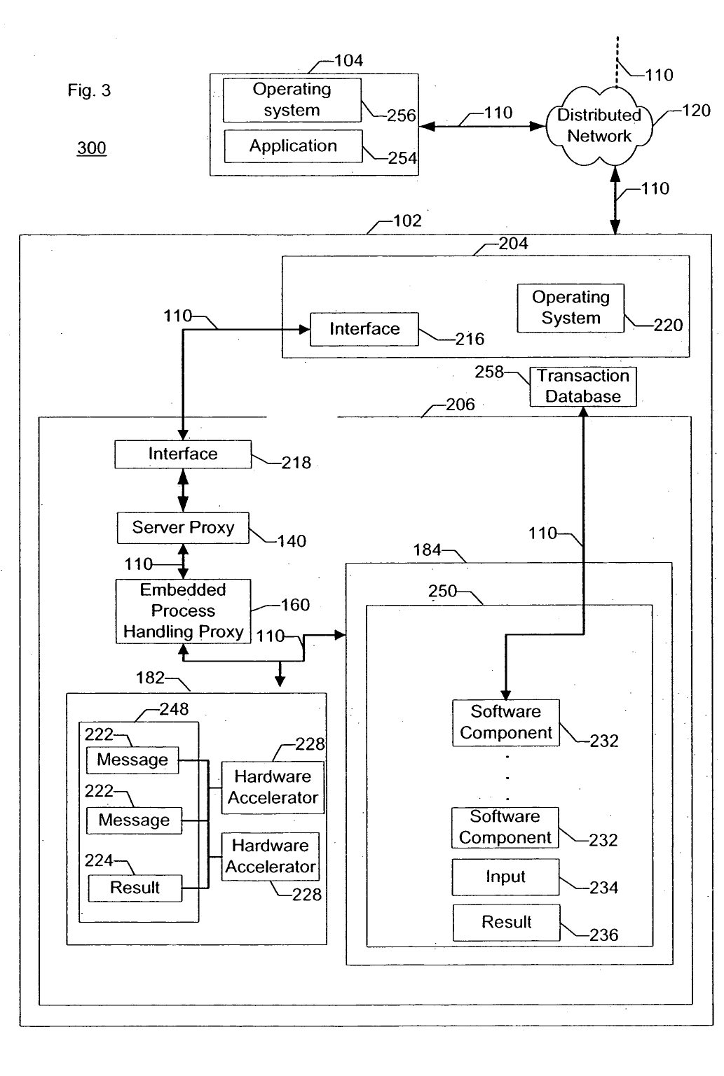

FIG. 3 shows a high-level block diagram of an exemplary embodiment of a system for providing access to embedded processes as network services 300 where the server proxy 140 may partially or fully reside on the embedded process unit 206. This exemplary embodiment of the invention may be useful in cases where the data transfer rate of the network interface is so high as to burden the processing resources of the server computer 104 or the bandwidth of the link 110. In this embodiment, the server proxy 140 may still transfer to the host server 102 notification of alerts arising from the processing of messages. An exemplary advantage of the embodiment shown in FIG. 3 is that the server may not have to perform handshaking protocols. Another exemplary advantage of the embodiment shown in FIG. 3 is that high data rate traffic may not be required to be transferred across the links 110 of the host server 102.

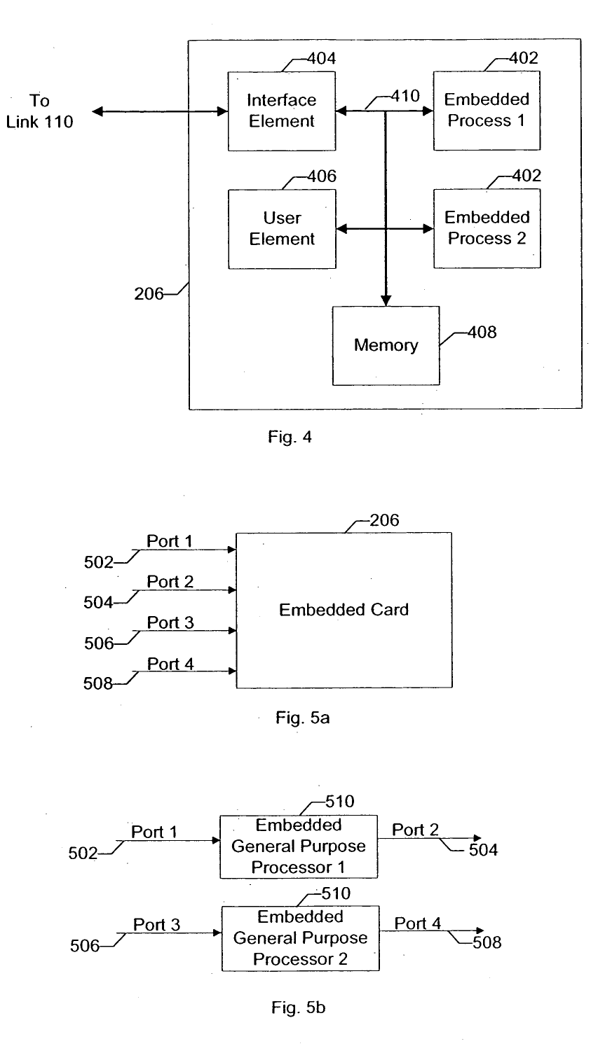

FIG. 4 shows a block diagram of the hardware of an exemplary embodiment of an embedded process unit 206. In this exemplary embodiment, the embedded process unit 206 comprises two embedded processes 402, an interface element 404, a user element 406, and a memory 408, all connected via links 410. Each of the embedded processes 402 may support one or more general-purpose processors and one or more hardware accelerators. The exemplary configuration shown in FIG. 4 has been adapted to support a total of four general-purpose processors and eight hardware accelerators as embedded processes. However, in general, it should be appreciated that the embedded process unit may contain various capacities and configurations of embedded processes and that any known or later developed processes may be employed on the embedded unit with equal success in accordance with this invention.

FIG. 5 shows two exemplary embodiments of an embedded process unit 206. In FIG. 5a, there are four physical network connections directly on the embedded process unit 206 and the embedded process unit 206 is configured to receive and examine any messages on the network, in a promiscuous listener mode and report on features of interest within a message. Such a configuration may be useful, for example, in an Intrusion Detection System (IDS) application, where the content of the messages is examined. In FIG. 5b, the four physical ports are configured in two pairs, with an embedded general-purpose processor 504 between each pair of ports. In this configuration, the embedded general-purpose processor 504 may not examine the content of each message due to time constraints, but rather may only look at the routing information and protocol information. Such a configuration may be useful, for example, in a firewall application.

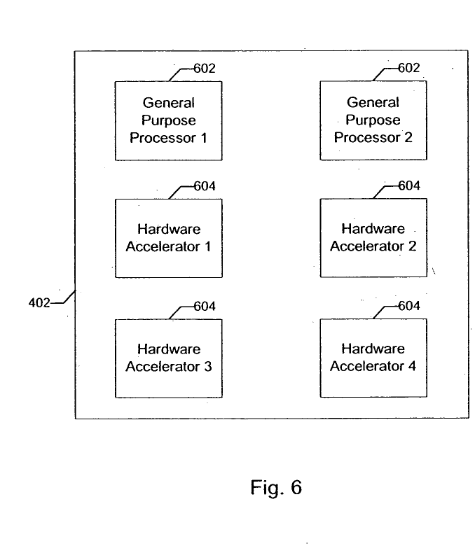

FIG. 6 is a functional block diagram of an exemplary embedded process 402. In particular, the embedded process 402 contains two general-purpose processors 602 and four hardware accelerators 604. The embedded process 402, for example, may function as a decoder, an encoder, a decryption processor, an encryption processor, a parser, a validation processor, a translator, a transaction processor, and/or the like. However, it should be appreciated that the embedded process 402 shown is an exemplary representation for illustration purposes only and, according to contemplated uses of the present invention, any combination of microprocessors, microcontrollers, digital signal processors, software objects, hardware accelerators, a hardwired electronic or logic circuit such as a discrete element circuit, a programmed logic device such as a PLD, PLA, FPGA, PAL, and/or the like may be used in the system with equal success. In another exemplary embodiment, the embedded process 402 may be able to be configured to delete or disable functions such as, for example, cryptography functions, which may be restricted by the government from exportation.

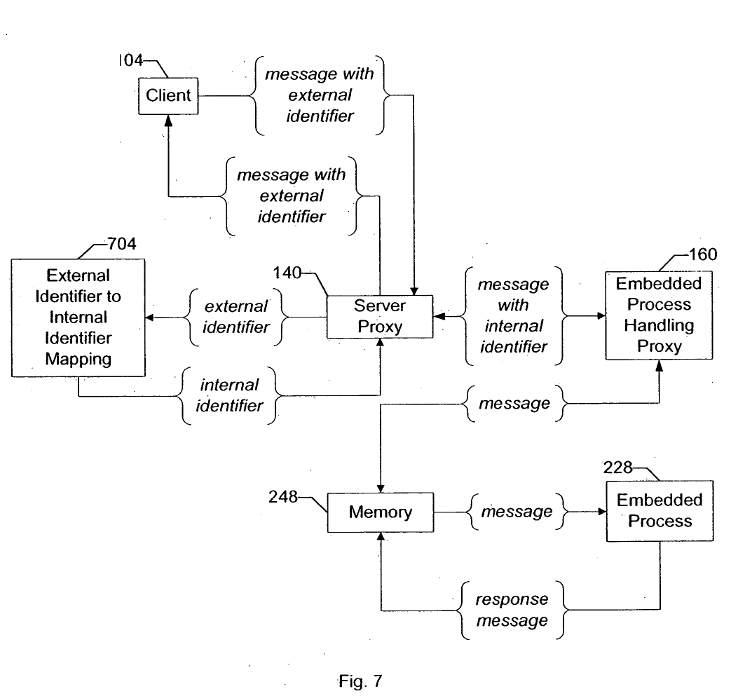

FIG. 7 is a diagram of the data flow in an exemplary embodiment of the present invention. In particular, the client 104 transmits a message containing an external identifier. The server proxy 140 receives a message containing an external identifier. The server proxy 140 maps the external identifier to an internal identifier using mapping 704, and transfers the message to the embedded process handling proxy 160. The embedded process handling proxy places the message in the embedded process memory 248. The embedded process 228 detects the message in memory 248, processes the message and places a resulting message in the embedded hardware accelerator memory 248. The result message is now available for further processing within the system, either by another embedded process or by the embedded process handling proxy 160. Once the processing has been completed and a response is generated, the embedded process handling proxy 160 will transfer the response message to the server proxy 140 for transmission to the client 104.

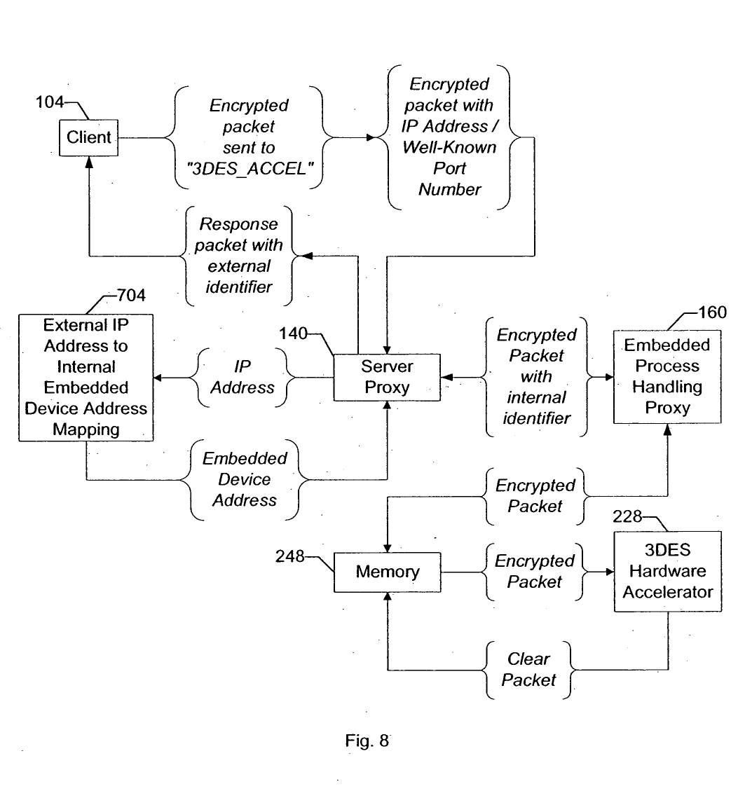

FIG. 8 is a diagram of the data flow in an exemplary embodiment of the present invention. In this particular exemplary embodiment, the client is sending a message to the embedded processes that requires decryption and then further processing. In particular, the client 104 sends an encrypted message to a server named “3DES_ACCEL” on a distributed network, for example, the Internet. The name “3DES_ACCEL” is resolved to an IP address. The message is then routed using the IP address to the server proxy 140 for the embedded process. The server proxy 140 maps the IP address/port number combination to the 3DES embedded hardware accelerator 228 and transfers the encrypted message to the embedded process handling proxy 160 using mapping 704, which places the message in the embedded hardware accelerator memory 248. The 3DES hardware accelerator 228 detects the received message, decrypts the message and places the resulting clear message in the embedded hardware accelerator memory 248. The clear message is now available for further processing within the system, either by another hardware accelerator or by the general-purpose processor. Once the processing has been completed and a response is generated, the embedded process handling proxy 160 will transfer the response message to the server proxy 140 for transmission to the client 104.

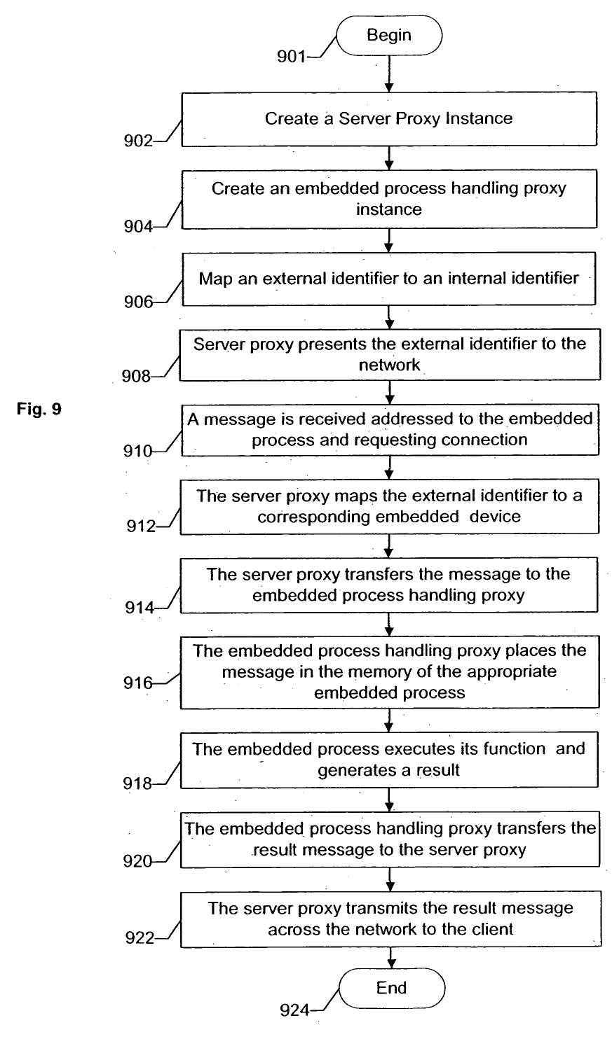

FIG. 9 is a flowchart of the exemplary steps in providing access to embedded processes as a network service. Control begins in step 901 and continues to step 902. Next, m step 902, a server proxy instance is created. The server proxy may be either multi-instance or multi-threaded, depending on resources available and contemplated uses. Then, in step 904, an embedded process handling proxy instance is created. The embedded process handling proxy may be may be either multi-instance or multi-threaded, depending on resources available and contemplated uses. Control then continues to step 906.

In step 906, the server proxy maps an external identifier to an internal identifier. Next, in step 908, the external identifier is presented to the network. Then, in step 910, a message is received addressed to the external identifier and requesting connection. Control then continues to step 912.

In step 912, the server proxy maps the external identifier to the appropriate internal address of the embedded process. Next, in step 914, the server proxy transfers the message to the embedded process handling proxy. Then, in step 916, the embedded process handling proxy places the message in the memory of the appropriate embedded process for processing. Control then continues to step 918.

In step 918, the embedded process processes the message and generates a response. Next, in step 920, the embedded process handling proxy transfers the response message to the server proxy. Then, in step 922, the server proxy transmits the response message across the network to the client. Control then continues to step 924. In step 924 the control sequence ends.

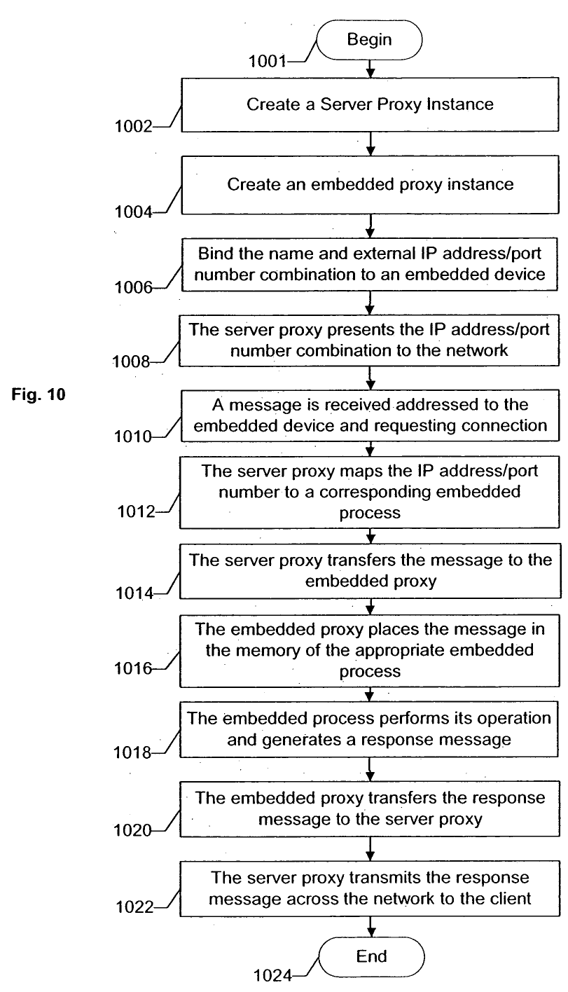

FIG. 10 is a flowchart of the steps of the method of providing access to embedded processes as network services. Control begins in step 1001 and continues to step 1002. Next, in step 1002, a server proxy instance is created. The server proxy may be either multi-instance or multi-threaded, depending on resources available and contemplated uses. Then, in step 1004, an embedded process handling proxy instance is created. The embedded process handling proxy may be either multi-instance or multi-threaded, depending on resources available and contemplated uses. Control then continues to step 1006.

In step 1006, the server proxy binds the name and external IP number/port number combination to an internal address of the embedded process. Next, in step 1008, the IP address/port number combination is presented to the network. Then, in step 1010, a message is received addressed to the IP address/port number combination corresponding to the embedded process and requesting connection to the embedded process. Control then continues to step 1012.

In step 1012, the server proxy maps the IP address/well-known port number combination to the appropriate internal address of the embedded process. Next, in step 1014, the server proxy transfers the message to the embedded process handling proxy. Then, in step 1016, the embedded process handling proxy places the message in the memory of the appropriate embedded process for processing. Control then continues to step 1018.

In step 1018, the embedded process processes the message and generates a response. Next, in step 1020, the embedded process handling proxy transfers the response message to the server proxy. Then, in step 1022, the server proxy transmits the response message across the network to the client. Control then continues to step 1024. In step 1024, the control sequence ends.

As shown in the above figures, the embedded processes can be implemented on a general-purpose computer, a special-purpose computer, a programmed microprocessor or microcontroller and peripheral integrated circuit element, and ASIC or other integrated circuit, a digital signal processor, a hardwired electronic or logic circuit such as a discrete element circuit, a programmed logic device such as a PLD, PLA, FPGA, PAL, or the like. In general, any process capable of implementing the flowcharts illustrated herein can be used to implement a system for accessing embedded processes according to this invention.

Furthermore, the disclosed method may be readily implemented in software using object or object-oriented software development environments that provide portable source code that can be used on a variety of computer platforms. Alternatively, the disclosed system for accessing embedded process as network services may be implemented partially or fully in hardware using standard logic circuits or a VLSI design. Other hardware or software can be used to implement the systems in accordance with this invention depending on the speed and/or efficiency requirements of the systems, the particular function, and/or a particular software or hardware system, microprocessor, or microcomputer system being utilized. The systems and methods for providing access to embedded processes as network services illustrated herein can readily be implemented in hardware and/or software using any known or later developed systems or structures, devices and/or software by those of ordinary skill in the applicable art from the functional description provided herein and with a general basic knowledge of the computer and network communication arts.

It is, therefore, apparent that there is provided in accordance with the present invention, systems and methods for accessing embedded processes as network services. While this invention has been described in conjunction with a number of embodiments, it is evident that many alternatives, modifications and variations would be or are apparent to those of ordinary skill in the applicable arts. Accordingly, applicants intend to embrace all such alternatives, modifications, equivalents and variations that are within the spirit and scope of this invention.

What is claimed is:

1. A system for providing access to an embedded process as a network service, comprising:
a server computer;
an embedded process, wherein the embedded process is interconnected to said server computer;
a data communications network connected to the server computer;
a server proxy means providing a connection between the server computer and the embedded process for presenting an external address of the embedded process to the network, receiving connection requests for the embedded process, and transferring communications messages received from said data communications network to said embedded process; and
an embedded process handling proxy means connected between said embedded process and said server proxy means for communicating data messages from the embedded process to said server proxy.

2. The system of claim 1, wherein the data communications network is connected to the embedded process.

3. The system of claim 1, wherein the embedded process is an electronic circuit for accelerating the processing of data.

4. The system of claim 1, wherein the embedded process is a general purpose computer.

5. The system of claim 1, wherein the data communications network is wireless.

6. The system of claim 1, wherein the data processing functions of the server proxy are divided between the server computer and the embedded process.

7. An embedded process processing system comprising:
a client; and
a server having an embedded process handling proxy adapted to route one or more process requests from the client to one or more embedded process, the embedded process handling proxy routing the one or more process requests based on a mapping of an external identifier to an internal identifier that specifies one or more particular embedded process.

8. The system of claim 7, wherein the embedded process is an electronic circuit for accelerating the processing of data.

9. The system of claim 7, wherein the embedded process comprises means for parsing extensible markup language.

10. The system of claim 7, wherein the embedded process comprises means for performing cryptographic processes.

11. A method for providing access to embedded processes as a network service, comprising:
a) receiving from a source a first message having an external identifier;
b) mapping the external identifier to an internal identifier, corresponding to one or more embedded processes; and
c) transmitting said first message to one or more embedded processes based on the internal identifier.

12. The method of claim 11, further comprising the steps of:
a) receiving a second message from one or more embedded processes in response to said first message; and
b) transmitting said second message.

13. The method of claim 12, wherein transmitting said second message comprises sending the second message to the source of the first message.
